(19) United States
(12) Patent Application Publication
(10) Pub. No.: US 2024/0005169 A1
(43) Pub. Date: Jan. 4, 2024

(54) PROCESS FOR TRAINING A FIRST ARTIFICIAL NEURAL NETWORK STRUCTURE, COMPUTER SYSTEM, COMPUTER PROGRAM AND COMPUTER-READABLE MEDIUM

(71) Applicant: Robert Bosch GmbH, Stuttgart (DE)

(72) Inventor: Mark den Hartog, VW Eindhoven (NL)

(21) Appl. No.: 18/255,142

(22) PCT Filed: Dec. 2, 2020
(86) PCT No.: PCT/EP2020/084237

§ 371 Date: May 31, 2023

(51) Int. Cl. G06N 3/088; G06N 3/045

(52) U.S. Cl. CPC G06N 3/088; G06N 3/045

(57) ABSTRACT

For computers to be able to make informed decisions (aka artificial intelligence), they must convert raw sensor data into an actionable information, using some form of ‘world model’. ‘Traditional’ algorithms use a human engineered model, tailored to the specific problem at hand. These algorithms typically required only limited amount of data samples during design/training, due to the narrow area of applicability and the limited number of free parameters. A process for improving a first artificial neural network structure (1) is disclosed, wherein data samples are classified in different classes (4) by the first artificial neural network structure (1), whereby at least some of the classes (4) are unsupervised classes (6), which are generated and/or filled by unsupervised learning, wherein for at least one of the unsupervised classes (6) a second artificial neural network structure (2) is trained to generate artificial candidates (7) belonging to the said unsupervised class (6), wherein the generated artificial candidates (7) are labelled and/or annotated in a supervised learning for labelling and/or annotating the said unsupervised class (7).

### BACKGROUND

For computers to be able to make informed decisions (aka artificial intelligence), they must convert raw sensor data into an actionable information, using some form of ‘world model’. ‘Traditional’ algorithms use a human engineered model, tailored to the specific problem at hand. These algorithms typically required only limited amount of data samples during design/training, due to the narrow area of applicability and the limited number of free parameters.

2012 saw a turning point in computer science, with the revival of neural networks for computer vision applications. In contrast to the traditional algorithms, the artificial algorithm do not rely on a rigid, engineered, model, but rather have so many free parameters, they can infer the model themselves from the given data samples. There are two major downsides to this approach:
1. The algorithms require a huge amount of data samples to prevent overfitting;
2. The algorithm must be taught how to interpret each individual data sample.

For the latter point, there are two main strategies:
1. Unsupervised learning;
2. Supervised learning.

(Very) roughly speaking, in supervised learning, every data sample is explicitly annotated with the desired outcome. For instance, a set of images are manually labelled with ‘cat’ or ‘climbing’ so the algorithm is able to distinguish the two.

For unsupervised learning, the algorithm is only given an abstract goal, with some additional constraints, like: ‘divide the data set in 20 distinct groups, and maximize the KL-divergence between groups. In the context of this ID, this also includes policy based learning methods. Although in this scenario the grouping is done without any human supervision, a human is still required to provide semantic meaning by labelling each group by looking at examples.

The document US 2006/0251292 A1, probably representing the closest prior art, discloses a system and method for recognising objects from images and identifying relevancy amongst images and information.

In one embodiment first a unsupervised learning step is performed, afterwards candidates in non-labelled classes are checked by users to match the people to email addresses or other personal identifiers, either while providing the photos, or after he sees the images. Still further, correlation between recognized persons in images and their identities may be established through a combination of unsupervised clustering and supervised recognition. The unsupervised clustering may group faces into clusters as described above. Next, the results are shown to the user. The user scan the results for purpose of correcting any mis-groupings and errors, as well as to combine two groups of images together if each image contains the same identity. According to the document, the algorithm obtains the accuracy of supervised learning, with minimal work-load on the user.

### SUMMARY

According to the invention a process or method for training a first artificial neural network structure, a computer system adapted for implementing the process, a computer program and a computer-readable medium are proposed.

Subject matter of the invention is a process for training a first artificial neural network structure. The first artificial neural network structure is preferably realised as an artificial neural network.

The artificial neural network structure is adapted to classify data samples from the input of the first artificial neural network structure into different classes at the output of the first artificial neural network structure. At least some of the classes are generated and/or filled by the first artificial neural network structure by unsupervised learning. These classes will be called unsupervised classes within the description. Unsupervised learning shall preferably be understood as a type of machine learning that looks for previously undetected patterns in a data set with no pre-existing labels and with a minimum or none of human supervision.

At least for one of the unsupervised classes, a second artificial neural network structure is trained generate artificial candidates belonging, especially seeming to belong to the said unsupervised class. In other words, the second artificial neural network structure generates fake data samples.

The generated artificial candidates are labelled and/or annotated in a supervised learning for labelling and/or annotating the said unsupervised class. According to the invention, only the artificial candidates are checked by human operators, annotated/labelled and thus the respective unsupervised class is also annotated/labelled.

The invention thus proposes a way to achieve a semi-supervised labelling or annotating for the unsupervised classes. The advantage of the invention is that no data samples of the unsupervised classes are disclosed to the human operators or leave the respective computer system at all. This process can for example be applied to distributed/edge/online learning, in scenarios where dataset or data samples preferably should not leave the premise/device.

In an improvement of the invention, the first artificial network structure is trained with the labelled and/or annotated artificial candidates in order to label and/or annotate the said unsupervised class. With this improvement, not only the labelling/annotating is transferred to the supervised class, but also the annotated/labelled artificial candidates are used to train the first artificial neural network structure in order to provide a semi-supervised class. In other words, the second artificial neural network structure provides fake data samples, which can be labelled and/or annotated by human operators and can be used by the first artificial neural network structure.

By jointly training a probability function only and not the full algorithm, sensitive data can be kept locally, while the outcome can be used globally. Thus it is preferred, that only the artificial candidates are presented to the human operators and that the original data samples in the unsupervised classes are kept restricted and/or secret.

In a preferred embodiment, the first artificial neural network structure is realised as a convolutional artificial neural network and/or that the data samples are images. The convolutional artificial neural network comprises at least one or a plurality of convolutional layers, at least one or a plurality of pooling layers and at least one or a plurality of fully connected layers. The convolutional neural network (CNN, or ConvNet) is a class of deep neural networks, preferably to be applied to analysing visual imagery. Additionally and/or alternatively the data samples are images, for example RGB-images. The aim of the first artificial neural network structure is to classify images.

It is further preferred, that a part of the classes are supervised classes, which are generated and/or filled by supervised learning. The supervised classes are based training data, which was labelled and/or annotated by human operators. The first artificial neural network structure comprises a part of supervised classes and a part of unsupervised classes. It is further preferred, that the main part are supervised classes and the minor part are unsupervised class. For example, more than 80% of the classes are supervised classes. Within this preferred embodiment, the unsupervised classes are just one small remaining part of the overall classes, so that most of the darter samples are classified in a supervised manner.

In a preferred embodiment the second artificial neural network structure is trained by improving of the probability density function of the respective unsupervised class. Simply speaking, by improving, especially reducing or minimising a loss function of the second neural network structure compared to the probability density function of the respective live unsupervised class, the second artificial neural network structure is improved, so that the artificial candidates represent members of the said unsupervised class in an improved manner. The loss function is especially the function that computes the distance between the current output of the second artificial neural network structure and the expected output based on the probability density function of the respective unsupervised class.

In a preferred realisation of the invention, the second artificial neural network structure comprises a generative artificial neural network. Especially, the generative artificial neural network embodies a generative model. The generative artificial neural network has the function to generate the artificial candidates and can be trained to provide improved artificial candidates.

In a first possible realisation the second artificial neural network structure comprises additionally a discriminative artificial neural network, whereby the generative and the discriminative artificial neural networks form a generative adversarial network, which is also called GAN. Simply spoken, the GAN achieve its function by pairing a generator, which learns to produce the artificial candidates, with a discriminator, which learns to distinguish data samples of the respective unsupervised class from the output of the generator. The generator tries to fool the discriminator, and the discriminator tries to keep from being fooled. With this corporation of generator and discriminator, improved artificial candidates are produced.

In a second realisation, the first artificial neural network structure is realised as a discriminative artificial neural network, whereby the said generative and this discriminative artificial neural network form are generative adversarial network (GAN), as defined above.

In the first realisation the GAN can concentrate on generating and improving the artificial candidates, so that the function is reduced to its core function and thus the GAN is reduced in complexity. In the second realisation the GAN comprises the first artificial neural network structure, so that the discriminator part of the GAN is identical to the discriminator as a realised in the first artificial neural network structure. So while training the GAN, the discriminator part can be kept constant and only the generator can be optimised to improve the artificial candidates.

In another realisation, the generative artificial neural network is a variational autoencoder. Such a variational autoencoder is for example described in Kingma, Diederik P and Welling, Max. Auto-encoding variational bayes. arXiv preprint arXiv:1312.6114, 2013. Further variational autoencoder and GANs are described in Lars Mescheder, Sebastian Nowozin, Andreas Geiger: Adversarial Variational Bayes: Unifying Variational Autoencoders and Generative Adversarial Networks arXiv:1701.04722v4/ Proceedings of the 34th International Conference on Machine Learning, Sydney, Australia, PMLR 70, 2017. The disclosure of the documents are integrated in the present description by reference.

It is preferred, that—concerning the or all unsupervised classes—, only the artificial candidates are labelled and/or annotated by you human operators.

A further subject matter of the invention concerns a computer's esteemed, whereby the computer system is adapted for implementing the process as described above. A further subject matter of the invention concerns a computer program as well as a computer readable medium.

### BRIEF DESCRIPTION OF THE DRAWINGS

Further features, advantages and effects of the invention will become apparent by the description of preferred embodiments of the invention and the figures as attached. The figures show:

FIG. 1 a schematic block diagram of a computer system as a first embodiment of the invention;

FIG. 2 a schematic block diagram of a computer system a second embodiment of the invention.

### DETAILED DESCRIPTION

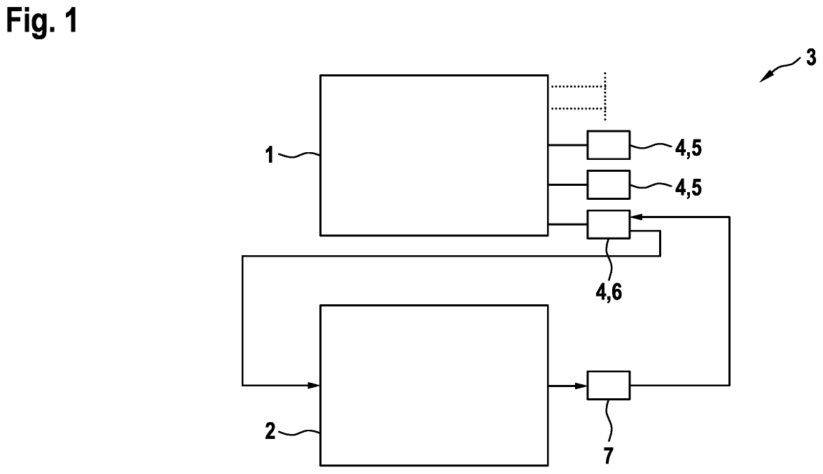

FIG. 1 shows a computer system 3 as an embodiment of the invention. The computer system 3 comprises a first artificial neural network structure 1 and a second artificial neural network structure 2.

The first artificial neural network structure 1 comprises an input for receiving data samples, which are embodied as images. For example the images are RGB-images. The first artificial neural network structure 1 is a convolutional artificial network and distributes the images in a plurality of classes 4, whereby a part of the classes 4 are generated or filled by supervised learning and are called supervised classes 5. Another part of the classes for our generated or filled by unsupervised learning and are called unsupervised classes 6.

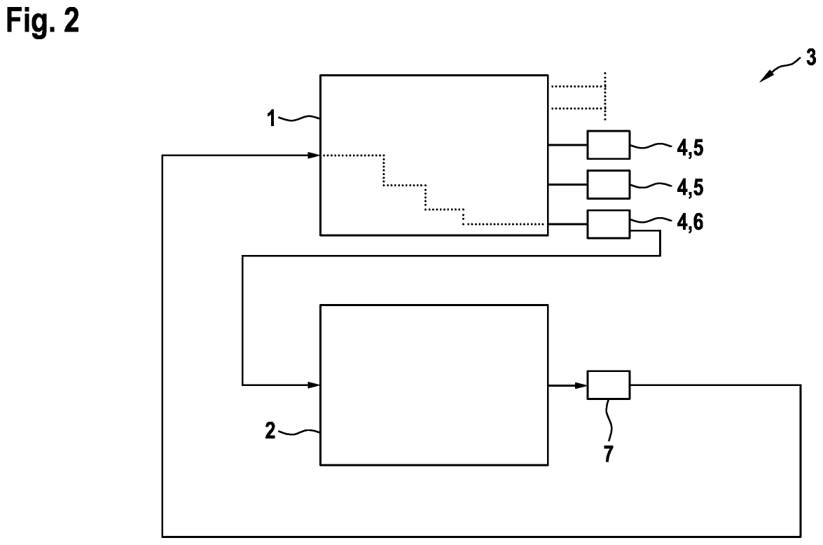

The data samples in the supervised classes 5 are annotated/labelled by human operators, the darter samples distributed into the unsupervised classes 6 are not labelled, so that the unsupervised classes 6 are also not labelled/annotated. To illustrate this, imagine an image classification example as shown in FIG. 1 or 2, where an unsupervised algorithm first splits the dataset in n-groups or n-classes 4, of which 80% (persons, cats, dogs, cars) are labelled and 20% are separated using unsupervised learning methods.

Next, the data samples or alternatively the probability density function of one of the unsupervised classes 6 are transferred to the second artificial neural network structure 2. The second artificial neural network structure 2 is realised as a GAN or at least as a generative artificial neural network like a variational autoencoder. The second artificial neural network structure is adapted to generate artificial candidates 7, which belong to the said unsupervised class. The artificial candidates 7 can be generated on basis of the data samples or, in case the data samples shall not leave the structure of the first artificial neural network 1, exclusively on basis of the probability density function of the unsupervised class 6. The step is to randomly generate new samples, especially based solely on the learned probability distribution.

In a next step, the artificial candidates 7 are labelled and/or annotated by human operators. In this case, the human annotator only see an artificially generated image and never has access to the individual data samples in the original data set. The annotation/labelling of the artificial candidates 7 can be transferred to the unsupervised class, so that the unsupervised class is labelled and/or annotated. The first embodiment thus illustrates a process for labelling and/or annotating the unsupervised class and its entirety.

In FIG. 2 another embodiment is shown, whereby the artificial candidates 7 are used as an input of the first artificial neural network structure 1. In this embodiment the artificial candidates 7 are classified into the unsupervised class 6, because the second artificial neural network 2 was adapted to generate such artificial candidates 7, which belong to the said unsupervised class 6. In this case the unsupervised class 6 comprises original data samples, which are not labelled/annotated and additionally artificial candidates 7, which are labelled/annotated, so that the unsupervised class 6 is labelled and/or annotated by means of a part of the classified samples.

In case the first artificial neural network 1 classifies the artificial candidates 7 not in the unsupervised class 6, but in another class 4 (regardless whether it's a supervised class 5 or are unsupervised class 6), the wrong-classified artificial candidates 7 can be returned to the second artificial neural network structure 2, in order to train the network structure of the second artificial neural network structure 2 and additionally the correct-classified artificial candidates 7 can also be returned to the second artificial neural network structure 2 in order to train the network structure of the second artificial neural network structure 2. In that case a GAN is established, whereby the first artificial neural network structure 1 is the discriminator and the second artificial neural network structure 2 is the generator.

Summarised, this invention disclosure describes an algorithm to allow data set labelling using artificially generated samples, preventing direct access to the original data and speeding up the data labelling process. This procedure can also be applied to distributed/edge/online learning, in scenarios where dataset preferably should not leave the premise/device. By jointly training a probability function only and not the full algorithm sensitive data can be kept locally, while the outcome can be used globally.

1. A process for improving a first artificial neural network structure (1), the process comprising:
classifying data samples in different classes (4) by the first artificial neural network structure (1), whereby at least some of the classes (4) are unsupervised classes (6), which are generated and/or filled by unsupervised learning, and
training a second artificial neural network structure (2) to generate artificial candidates (7) belonging to at least one of the unsupervised classes (6),
wherein the generated artificial candidates (7) are labelled and/or annotated in a supervised learning for labelling and/or annotating the said unsupervised class (7).

2. The process according to claim 1, wherein the process is a process for image classification whereby the data samples are images especially taken by at least one surveillance camera.

3. The process according to claim 1, wherein the first artificial network structure (1) is trained with the labelled and/or annotated artificial candidates (7) in order to label and/or annotate the said supervised class (6).

4. The process according to claim 1, wherein the first artificial neural network structure (1) is a convolutional artificial neural network and/or that the data samples are images.

5. The process according to claim 1, wherein a part of the classes (4) are supervised classes (5), which are generated and/or filled by supervised learning.

6. The process according to claim 1, wherein the second artificial neural network structure (2) is trained by improving a loss-function of the probability density function of the respective unsupervised class (6).

7. The process according to claim 1, wherein the second artificial neural network structure (2) comprises a generative artificial neural network.

8. The process according to claim 7, wherein the second artificial neural network structure (2) comprises a discriminative artificial neural network, whereby the generative and the discriminative artificial neural network form a generative adversarial network (GAN).

9. The process according to claim 7 wherein the first artificial neural network structure (1) is realized as a discriminative artificial neural network, whereby the generative and the discriminative artificial neural network form a generative adversarial network (GAN).

10. The process according to claim 7, wherein the generative artificial neural network is a variational autoencoder (VAEs).

11. The process according to claim 1, wherein the unsupervised class (6) only the artificial candidates (7) are labelled and/or annotated.

12. A computer system (3) adapted for implementing the process according to claim 1.

13. (canceled)

14. A non-transitory, computer-readable medium having stored thereon instructions that when executed by a computer cause the computer to:
classify data samples in different classes (4) by a first artificial neural network structure (1), whereby at least some of the classes (4) are unsupervised classes (6), which are generated and/or filled by unsupervised learning, and
train a second artificial neural network structure (2) to generate artificial candidates (7) belonging to at least one of the unsupervised classes (6),
wherein the generated artificial candidates (7) are labelled and/or annotated in a supervised learning for labelling and/or annotating the said unsupervised class (7).
